(19) United States
(12) Patent Application Publication
(10) Pub. No.: US 2009/0295264 A1
(43) Pub. Date: Dec. 3, 2009

(54) LED LAMP PROVIDED WITH BLOWER

(75) Inventor: Hiroyuki FUKUI, Kyoto-shi (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 12/473,002

(22) Filed: May 27, 2009

(30) Foreign Application Priority Data
May 28, 2008 (JP) 2008-139715

(51) Int. Cl. H01J 61/52

(52) U.S. Cl. 313/46

(57) ABSTRACT

An LED lamp includes a plurality of light-emitting diodes, a blower for cooling the light-emitting diodes, and a tubular member for accommodating the light-emitting diodes and the blower. The tubular member is provided with an air inlet and an air outlet spaced from each other. The blower is an electric micro-fan for example, and adapted to generate an air flow from the air inlet toward the air outlet in the tubular member.

### BACKGROUND OF THE INVENTION

1. Field of the Invention

The present invention relates to an LED lamp using light-emitting diodes as light source.

2. Description of the Related Art

Fluorescent lights (or fluorescent lamps) are widely used as an illuminator. Fluorescent lamps, however, have drawbacks that the life is relatively short, and that use is made of a harmful substance such as mercury. Thus, as a substitute for fluorescent lamps, LED lamps are proposed, which use light-emitting diodes (LEDs) as the light source.

FIG. 8 is a sectional view showing an example of conventional LED lamp (see JP-U-H06-54103). The illustrated LED lamp X includes: an elongated supporting plate 91; LEDs 92 mounted on the supporting plate 91; a tube 93 in which the supporting plate 91 is accommodated; and terminals 94. The surface of the supporting plate 91 is formed with a wiring pattern connected to the LEDs 92 and the terminals 94.

In the LED lamp X, the LEDs 92 produce some heat during the operation, thereby heating the supporting plate 91 and the LEDs 92 themselves. As a result, the LEDs 92 may deteriorate and reach its life span sooner than expected.

### SUMMARY OF THE INVENTION

The present invention has been proposed under the circumstances described above. It is, therefore, an object of the present invention to provide an LED lamp having a longer life.

An LED lamp provided according to the present invention includes: a plurality of light-emitting diodes; a tubular member accommodating the light-emitting diodes and provided with an air inlet and an air outlet; and a blower for generating an air flow from the air inlet toward the air outlet in the tubular member.

Preferably, the LED lamp of the present invention may further include a base plate including an obverse surface for mounting the light-emitting diodes. The blower may be arranged to produce an air flow at least on a side of the obverse surface of the base plate.

Preferably, the LED lamp of the present invention may further include a heat dissipation member supporting the light-emitting diodes. In this case, the heat dissipation member may be formed with at least one air hole through which the blower causes the air to flow.

The blower may be an electric micro-fan including a plurality of rotation blades.

Preferably, the LED lamp of the present invention may further include a temperature sensor that cooperates with the blower. In this case, the operation of the blower may be controlled in accordance with the temperature detected by the temperature sensor. When the blower is a micro-fan including a plurality of rotation blades, the number of revolutions of the rotation blades may be varied in accordance with the temperature detected by the temperature sensor.

Other features and advantages of the present invention will become more apparent from the detailed description given below with reference to the accompanying drawings.

### BRIEF DESCRIPTION OF THE DRAWINGS

FIG. 1 is a plan view showing an LED lamp according to a first embodiment of the present invention.

FIG. 2 is a plan view showing the internal structure of the LED lamp of FIG. 1.

FIG. 3 is a sectional view taken along lines III-III in FIG. 2.

FIG. 4 is a sectional view taken along lines IV-IV in FIG. 2.

FIG. 5 is a plan view showing an LED lamp according to a second embodiment of the present invention.

FIG. 6 is a plan view showing an LED lamp according to a third embodiment of the present invention.

FIG. 7 is a sectional view taken along lines VII-VII in FIG. 6.

FIG. 8 is a sectional view showing an example of conventional LED lamp.

### DETAILED DESCRIPTION OF THE PREFERRED EMBODIMENTS

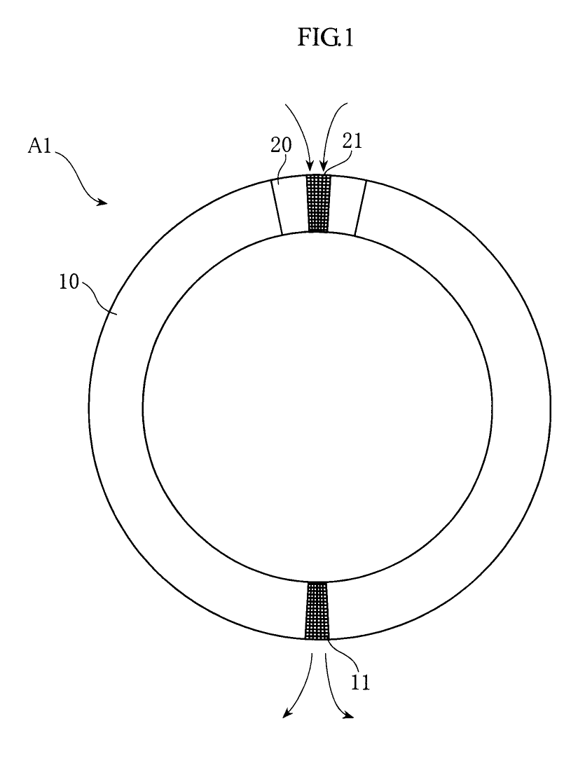

FIGS. 1-4 illustrate an LED lamp A1 according to a first embodiment of the present invention.

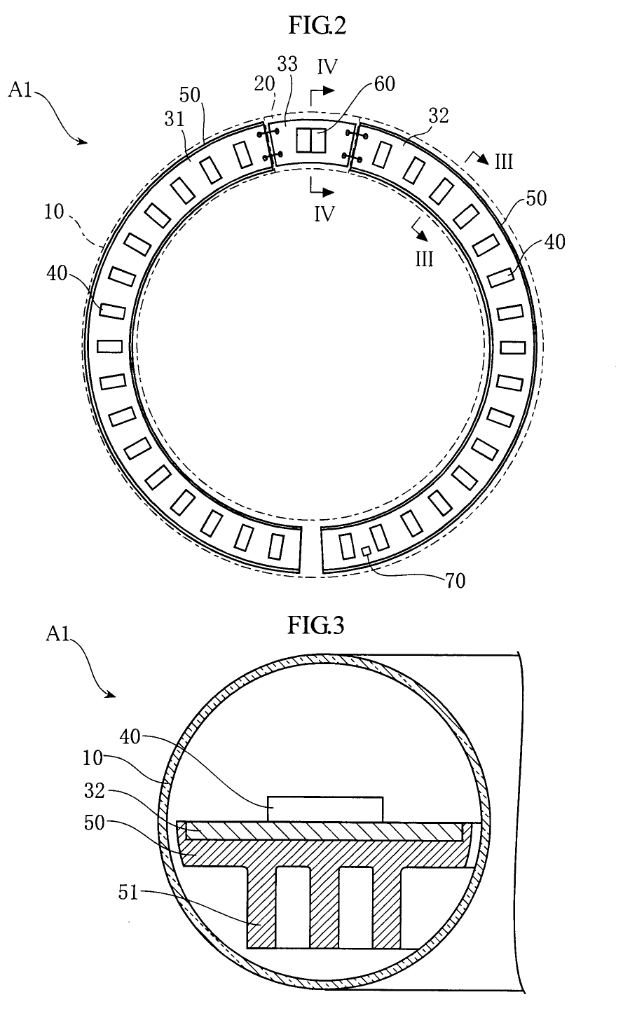

As shown in FIG. 1, the LED lamp A1, which is annular as a whole, includes a diffusion pipe 10 and a tubular base 20. FIG. 2 is a plan view showing the interior of the diffusion pipe 10 and the base 20. As shown in FIGS. 2-4, a pair of base plates 31, 32, a control board 33, a plurality of LED modules 40, heat dissipation members 50 and blowers 60 are arranged in the diffusion pipe 10 and the base 20. The LED lamp A1 is configured to be attached to a lighting appliance to be used as a substitute for an annular fluorescent lamp.

The diffusion pipe 10 is adapted to diffuse the light emitted from the LED modules 40 for emission to the outside. The diffusion pipe 10 is shaped like a torus, with a predetermined portion cut away as viewed in plan, and the base 20 is fitted in the cutout portion. The diffusion pipe 10 is formed with an air outlet 11 at the farthest position from the base 20. The air outlet 11 may be in the form of a mesh to allow the air to be discharged from the diffusion pipe 10 to the outside.

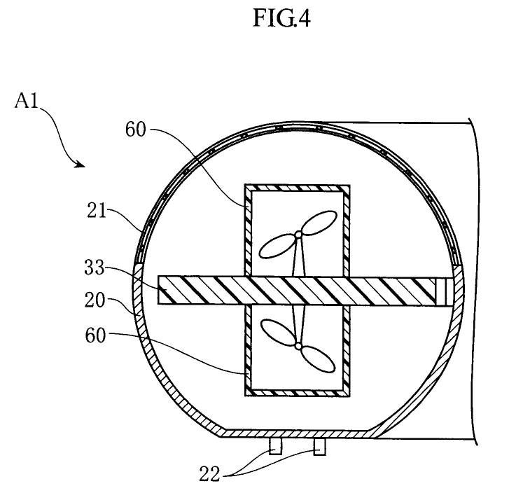

The base 20 is provided with an air inlet 21 and a terminal pin 22 (see FIG. 4). The air inlet 21 may be in the form of a mesh and is designed to allow the outside air to be sucked into the base 20. The terminal pin 22 is electrically connected to the control board 33. By fitting the terminal pin into a socket of a fluorescent illuminator, electric power is supplied to the control board 33.

As shown in FIG. 2, the base plate 31 is semicircular in plan view and accommodated on one side (left half in FIG. 2) of the diffusion pipe 10. Similarly, the base plate 32 is semicircular in plan view and accommodated on the other side (right half) of the diffusion pipe 10. On the obverse surface of each of the base plates 31 and 32, LED modules 40 are arranged in the circumferential direction at predetermined intervals. The obverse surfaces of the base plates 31 and 32 are formed with a wiring pattern (not shown) electrically connected to the LED modules 40. The base plates 31 and 32 are made of e.g. aluminum, and the obverse surfaces (the surface on which LED modules 40 are mounted) are covered with an insulating film. As shown in FIG. 3, one of the two heat dissipation members 50 is bonded to the reverse surface of each of the base plates 31 and 32.

The control board 33 is accommodated in the base 20 and receives power supply through the terminal pin 22. The control board is electrically connected to the wiring pattern on the base plates 31 and 32. On the control board 33, a controller for controlling the LED modules 40 is mounted. As shown in FIG. 4, blowers 60 are arranged on the obverse surface and the reverse surface of the control board 33.

Each of the LED modules 40 includes at least one LED and a resin package covering the LED. The LED modules emit light when receiving power supply from the control board 33 through the wiring pattern on the base plates 31, 32. The LED incorporated in each LED module may have a laminated structure made up of an n-type semiconductor layer, a p-type semiconductor layer and an active layer sandwiched between these layers. When a GaN-based semiconductor is used as the material of the LED, the LED emits blue light. The resin package is made of a resin (e.g. silicone resin) which transmits the light emitted from the LED. A fluorescent material which emits yellow light when excited by blue light may be mixed in the resin package. In this case, white light is emitted from the LED module 40 due to the mixing of blue and yellow.

Each of the heat dissipation members 50 is made of e.g. aluminum to have a semicircular shape in plan view and supports the LED modules 40 via the base plate 31 or 32. The heat dissipation member 50 includes a plurality of heat dissipation fins 51 projecting from the reverse surface. The heat dissipation fins 51 extend in parallel to each other in the circumferential direction of the heat dissipation member 50.

The blowers 60 may be an electric micro-fan and include a plurality of rotation blades and a motor for driving the blades. Preferably, a plurality of micro-fans are used to send air individually toward the obverse surface side and the reverse surface side of each base plate 31, 32. FIG. 4 shows two micro-fans arranged on the obverse surface and the reverse surface of the control board 33 to send air to the obverse surface side and the reverse surface side of the base plate 32, respectively (see FIG. 2). Similarly, two micro-fans for sending air to the obverse surface side and the reverse surface side of the base plate 31 are also arranged on the obverse surface and the reverse surface of the control board 33.

The blowers (upper blowers) 60 on the obverse surface of the control board 33 cause the air, which is in direct contact with the LED modules 40 on the obverse surface of the base plate 31, 32, to flow from the air inlet 21 toward the air outlet 11. The blowers (lower blowers) 60 on the reverse surface of the control board 33 cause the air, which is in contact with the heat dissipation members 50 bonded to the reverse surface of the base plate 31, 32, to flow from the air inlet 21 toward the air outlet 11. In this process, in addition to the air which is in contact with the periphery of the heat dissipation members 50, the air between the heat dissipation fins 51 is also caused to flow from the air inlet 21 toward the air outlet 11.

The advantages of the LED lamp A1 are described below.

In the foregoing embodiment, due to the upper and the lower blowers 60, the air on the obverse and the reverse surfaces of the base plates 31 and 32 flows from the air inlet 21 toward the air outlet 11. Thus, the air heated by the LED modules 40 in the diffusion pipe 10 is discharged to the outside from the air outlet 11, while the outside air (having a relatively low temperature) enters the diffusion pipe 10 from the air inlet 21. Thus, the LED modules 40 in the LED lamp A1 cool quickly. The LED modules 40 are efficiently cooled particularly because air flows between the heat dissipation fins 51 of the heat dissipation members 50. As a result, the deterioration of the LEDs in the LED modules 40 is suppressed, which leads to a long life.

Preferably, the LED lamp A1 is provided with at least one temperature sensor (e.g. thermocouple or thermistor) which cooperates with the electric micro-fans via a predetermined controller. In the example shown in FIG. 2, a temperature sensor 70 is arranged at an end of the base plate 32. With this arrangement, the temperature sensor detects the temperature in the LED lamp A1, and the operation of each micro-fan can be controlled based on the detection result. Specifically, when the temperature detected by the temperature sensor is not higher than a threshold, the micro-fans are kept stopped (the number of revolutions of the blades is 0). When the temperature detected is higher than the threshold, the micro-fans are driven. In the driven state, the number of revolutions of the blades may be kept constant. Alternatively, the number of revolutions of the blades may be varied depending on the temperature detected. In this case, it is preferable that the number of revolutions increases stepwise (or continuously) in accordance with an increase in the temperature detected. However, to suppress the noise caused by the driving of the micro-fans, it is preferable that the maximum number of revolutions of the blades is set to e.g. about 5000 revolutions per minute.

FIGS. 5-7 show LED lamps according to other embodiments of the present invention. In these figures, the elements which are identical or similar to those of the first embodiment are designated by the same reference signs as those used for the first embodiment, and the description is omitted appropriately.

FIG. 5 is a plan view showing an LED lamp A2 according to a second embodiment of the present invention. Similarly to the LED lamp Al, the LED lamp A2 is annular in plan view. In the LED lamp A2, an air outlet 11 is formed at an end of the diffusion pipe 10 in the circumferential direction, whereas an air inlet 12 is formed at the other end of the diffusion pipe. Thus, the air outlet 11 and the air inlet 12 are closer to each other in the second embodiment than in the first embodiment. A blower is provided in the base 20 so that air is caused to flow in the diffusion pipe 10 in the circumferential direction (clockwise in FIG. 5) from the air inlet 12 toward the air outlet 11.

Similarly to the LED lamp A1, the air outlet 11 and the air inlet 12 of the LED lamp A2 are in the form of a mesh. The blower may be an electric micro-fan. Similarly to the first embodiment, the micro-fan may be mounted on a control board provided in the base 20.

In the LED lamp A2, the air in the diffusion pipe 10 is discharged to the outside from the air outlet 11, while the outside air enters the diffusion pipe 10 from the air inlet 12, similarly to the LED lamp A1. Thus, the LED modules in the diffusion pipe 10 are efficiently cooled.

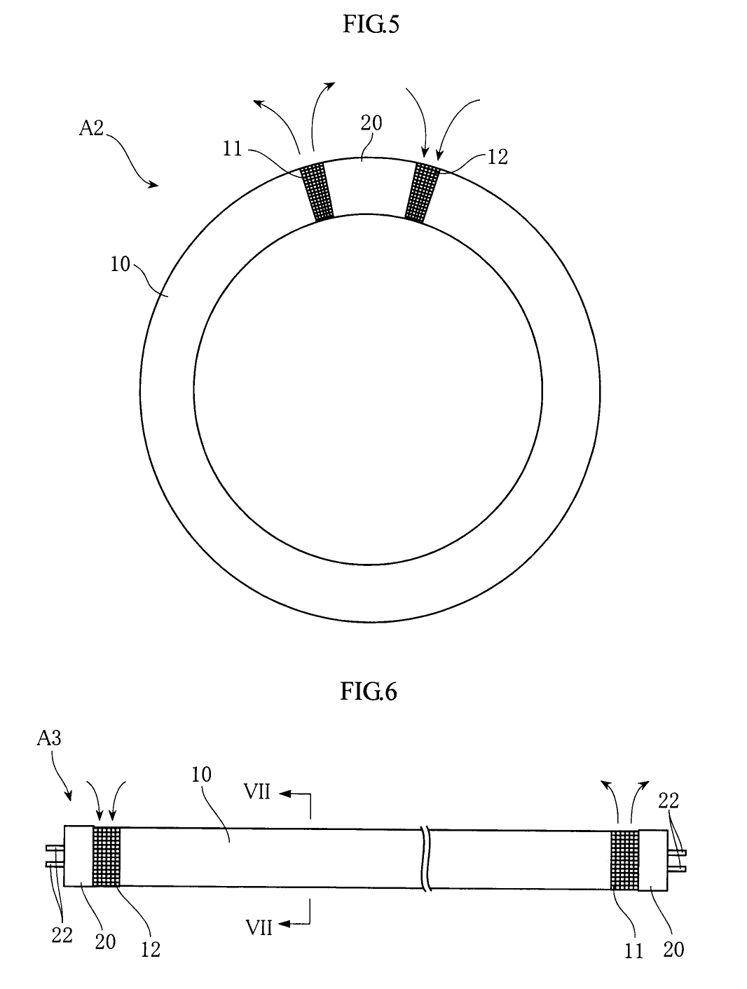

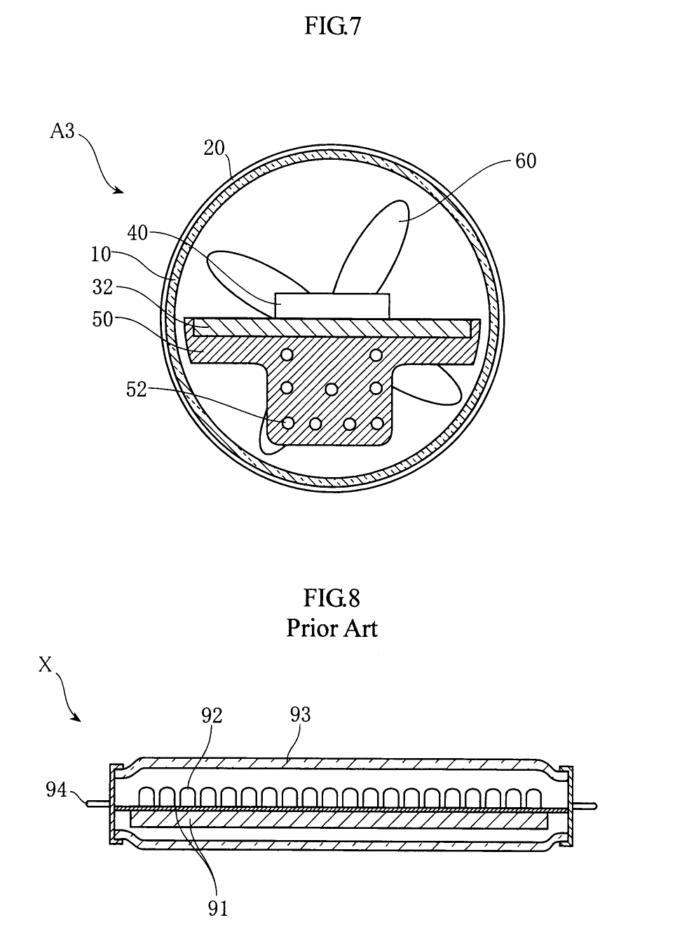

FIGS. 6 and 7 show an LED lamp A3 according to a third embodiment of the present invention. The LED lamp A3 is in the form of a straight tube and includes a diffusion pipe 10, a pair of bases 20, a base plate 32, a plurality of LED modules 40, a heat dissipation member 50 and a blower 60. The LED lamp A3 can be used as a substitute for e.g. a straight-tube type fluorescent lamp.

The diffusion pipe 10 of the LED lamp A3 is in the form of a thin straight tube and formed with an air outlet 11 in the form of a mesh at an end (right end in FIG. 6) and an air inlet 12 in the form of a mesh at the other end (left end). The bases 20 are provided at the two ends of the diffusion pipe 10, respectively. Each of the bases 20 is provided with two terminal pins 22 to be fitted into a socket of a general fluorescent illuminator.

The base plate 32 of the LED lamp A3 is in the form of an elongated rectangle extending in the longitudinal direction of the diffusion pipe 10. The LED modules 40 are arranged on the obverse surface of the base plate 32 at predetermined intervals in the longitudinal direction of the diffusion pipe 10. The obverse surface of the base plate 32 is formed with a wiring pattern electrically connected to the LED modules 40. The base plate 32 is made of e.g. aluminum, and the obverse surface is covered with an insulating film. The heat dissipation member 50 is bonded to the reverse surface of the base plate 32.

The heat dissipation member 50 of the LED lamp A3 is made of e.g. aluminum and in the form of an elongated rectangle in plan view. As shown in FIG. 7, the reverse surface of the heat dissipation member 50 is integrally formed with a bulging portion at the center. The bulging portion extends in the longitudinal direction of the base plate 32. The bulging portion is formed with a plurality of air holes 52. Each of the air holes 52 is a through-hole extending in the longitudinal direction of the heat dissipation member 50.

The blower 60 may be an electric micro-fan. The micro-fan may be arranged at an end (left end in FIG. 6) of the base plate 32 and has a diameter (the length from the rotation axis to the end of each blade×2) which is equal (or substantially equal) to the width of the heat dissipation member 50. When driven, the micro-fan sends air from the end of the base plate 32 toward the other end (right end) of the base plate. With this arrangement, the blower 60 causes the air, which is in direct contact with the LED modules 40 on the obverse surface of the base plate 32, to flow from the air inlet 12 toward the air outlet 11. Further, the blower 60 causes the air, which is in contact with the heat dissipation member 50, to flow from the air inlet 12 toward the air outlet 11. In this process, in addition to the air which is in contact with the periphery of the heat dissipation member 50, the air in each of the air holes 52 is also caused to flow from the air inlet 12 toward the air outlet 11. To achieve this air flow, each blade of the micro-fan needs to have a sufficient length. In the example shown in FIG. 7, the end of each blade projects downward beyond the lower surface of the bulging portion.

The LED lamp according to the present invention is not limited to the foregoing embodiments. For instance, although the air inlet 12, 21 and the air outlet 11 are in the form of a mesh in the foregoing embodiments, any other structure may be employed as long as they allow air to flow in and out. The positions of the air inlet and the air outlet can also be changed. Although blowers 60 are provided on both of the obverse and the reverse surfaces of the control board 33 in the first embodiment, the blower may be provided on only one of the surfaces of the control board. Further, the size, number, arrangement, etc., of the blowers 60 can be varied appropriately. For instance, a blower (e.g. the blower 60 of the third embodiment) may be arranged between the base plates 31 and 32 of the LED lamp A1 (see FIG. 2).

In the foregoing embodiments, the heat dissipation member 50 is used to facilitate heat dissipation. However, the heat dissipation member may be dispensed with to reduce the weight of the LED lamp as a whole. In such an instance, the LED modules 40 can be cooled properly by the blower 60.

1. An LED lamp comprising:
a plurality of light-emitting diodes;
a tubular member accommodating the light-emitting diodes and provided with an air inlet and an air outlet; and
a blower for generating an air flow from the air inlet toward the air outlet in the tubular member.

2. The LED lamp according to claim 1, further comprising a base plate including an obverse surface for mounting the light-emitting diodes, wherein the blower is arranged to cause air on a side of the obverse surface of the base plate to flow.

3. The LED lamp according to claim 1, further comprising a heat dissipation member supporting the light-emitting diodes, wherein the heat dissipation member is formed with an air hole through which the blower causes air to flow.

4. The LED lamp according to claim 1, wherein the blower includes a plurality of rotation blades.

5. The LED lamp according to claim 1, further comprising a temperature sensor cooperating with the blower.

6. The LED lamp according to claim 5, wherein operation of the blower is controlled in accordance with a temperature detected by the temperature sensor.

7. The LED lamp according to claim 6, wherein the blower is a micro-fan including a plurality of rotation blades, and number of revolutions of the rotation blades is variable in accordance with the temperature detected by the temperature sensor.
